(19) United States
(12) Patent Application Publication
(10) Pub. No.: US 2018/0044254 A1
(43) Pub. Date: Feb. 15, 2018

(54) Granular Urea Fertilizer with Nitrogen Stabilizer Additives

(71) Applicant: Koch Agronomic Services, LLC, Wichita, KS (US)

(72) Inventors: Kurt Gabrielson, Lilburn, GA (US); Allen Sutton, Corydon, KY (US); Kwame Owusu-Adom, Stone Mountain, GA (US); Dan Kuttenkuler, Festus, MO (US)

(73) Assignee: Koch Agronomic Services, LLC, Wichita, KS (US)

(21) Appl. No.: 15/552,675

(22) PCT Filed: Feb. 18, 2016
(86) PCT No.: PCT/US16/18489

§ 371 Date: Aug. 22, 2017

Related U.S. Application Data
(60) Provisional application No. 62/120,101, filed on Feb. 24, 2015.

(51) Int. Cl. C05G 3/08; C05C 9/00; C05G 3/00

(52) U.S. Cl. CPC C05G 3/08; C05G 3/0058; C05C 9/005

(57) ABSTRACT

This invention relates to a urea granule with a nitrogen stabilizer and carrier system substantially homogenously dispersed throughout the granule thickness. Several methods are disclosed to make the urea granule, including prilling, fluidized bed, and drum granulation. The carrier system can comprise any solvent system that is both: (1) stable at urea melt temperatures of ˜120° C.; (2) able to solvate the nitrogen stabilizer system; and (3) miscible in molten urea. Such carrier systems can be blends of NMP and a glycol (e.g. propylene glycol). The nitrogen stabilizer can include a urease inhibitor, such as NBPT, where the NBPT purity can be between 90 and 99%. The nitrogen stabilizer can also include a nitrification inhibitor, such as DCD.

### RELATED CASES

This is a 371 application of PCT/US16/18489 filed Feb. 18, 2016, which claims priority to U.S. Provisional Patent Application No. 62/120,101 filed Feb. 24, 2015, the disclosure of which is incorporated herein by reference in its entirety.

### FIELD OF ART

The present invention relates to an improved urea-nitrogen stabilizer fertilizer composition having a nitrogen stabilizer and carrier system substantially homogenously dispersed throughout the granule thickness.

### BACKGROUND OF THE INVENTION

Granular and prilled urea are the most widely used and agriculturally important nitrogen fertilizers. One approach toward improving the availability of the nitrogen from urea to act as a fertilizer is to use a nitrogen stabilizer such as a urease inhibitor or a nitrification inhibitor (Gardner, Ag Retailer, November 1995; Marking, Soybean Digest, November 1995, Varel et al., Journal of Animal Science 1999, 77(5); Trenkel “Slow and Controlled-Release and Stabilized Fertilizers, 2010). Slowing the urease-catalyzed transformation of urea to ammonium minimizes ammonia losses and allows time for absorption or dissipation of the nitrogen (N) forms into the soil. Reductions in ammonia volatilization from using urease inhibitors can range from 55 to over 99% (Watson et al., Soil Biology & Biochemistry 26 (9), 1165-1171, 1994), with a typical volatilization reduction of 75 to 80% in the field environment. One commercially used urease inhibitor is the compound NBPT, N-(n-butyl) thiophosphoric triamide, which is a pro-compound of its active oxygenated derivative, N-(n-butyl) phosphoric triamide (Phongpan et al., Fertilizer Research 41(1), 59-66, 1995). NBPT has been used as a coating on granular urea (see e.g. U.S. Pat. No. 5,698,003) or an additive to aqueous solutions of urea (see e.g. U.S. Pat. No. 5,364,438). Examples of nitrification inhibitors include, but are not limited to, dicyandiamide (DCD), 2-chloro-6-trichloromethylpyridine (nitrapyrin), 3,4-dimethylpyrazole phosphate (DMPP), 3-methylpyrazole (MP); 1-H-1,2,4-triazole (TZ); 3-methylpyrazole-1-carboxamide (CMP); 4-amino-1,2,4-triazole (AT, ATC); 3-amino-1,2,4-triazole; 2-cyanimino-4-hydroxy-6-methylpyrimidine (CP); 2-ethylpyridine; ammonium thiosulfate (ATS); sodium thiosulfate (ST); thiophosphoryl triamide; thiourea (TU); guanylthiourea (GTU); ammonium polycarboxilate; ethylene urea; hydroquinone; phenylacetylene; phenylphosphoro diamidate; neemcake; calcium carbide; 5-ethoxy-3-trichloromethyl-1,2,4-thiadiazol (etridiazol; terraole); 2-amino-4-chloro-6-methylpyrimidine (AM); 1-mercapto-1,2,4-triazole (MT); 2-mercaptobenzothiazole (MBT); 2-sulfanilamidothiazole (ST); 5-amino-1,2,4-thiadiazole; 2,4-diamino-6-trichloromethyl-s-triazine (CL-1580); N-2,5-dichlorophenyl succinanilic acid (DCS); nitroaniline, and chloroaniline.

The addition of urease and nitrification inhibitors into a urea melt is taught in U.S. Pat. No. 5,352,265 to Weston. The urease inhibitor and nitrification inhibitor is solvated prior to addition into the urea melt using either amides, 2-pyrrolidone, or N-alkyl 2-pyrrolidones, including N-methyl-2-pyrrolidones (NMP). According to Weston, NBPT is poorly soluble in water, aqueous solutions, and organic solvents. Additionally, the max purity of the NBPT in Weston is 80%, which requires excess NBPT to be added.

### BRIEF SUMMARY OF THE INVENTION

Ideally, a precise dosing of urea from the urea granulate is released in a controlled manner in the field. This requires urea granulates with precise grain sizes, density/hardness, and solidity to comply with these precise specifications. This is complicated when additives, such as a urease or nitrification inhibitor are added to the urea. Accordingly, there is a need for uniform compositions where a nitrogen stabilizer is combined with molten urea that uses substantially less NMP and/or nitrogen stabilizer. Further, there is a need for improved compositions that use less nitrogen stabilizer by minimizing degradation and other side-products formed during the manufacturing process. Moreover, there is a need for urea-stabilized fertilizers with improved NBPT storage stability.

The problems addressed above can be solved by forming a urea granule with a nitrogen stabilizer and carrier system substantially homogenously dispersed throughout the granule thickness. In one aspect, the combination of substantial homogeneity, no DCD, and an organic solvent carrier surprisingly results in a urea fertilizer with high available nitrogen when compared to a product containing DCD. In a second aspect, it was surprisingly found that the purity of the NBPT impacts the NBPT stability during storage, regardless if DCD is present. Specifically, the lower the NBPT purity the lower the NBPT stability (i.e. shelf-life) during storage, thus resulting in a fertilizer product with low nitrogen use efficiency. The homogeneity of the carrier system is related to the miscibility of the carrier system in the molten urea. Further, the higher the miscibility of the carrier system, the less time the nitrogen stabilizer stays at high temperature, therefore preventing unwanted composition breakdown or side reactions. The molten urea-nitrogen stabilizer composition is used to create fertilizer granules or prills using conventional means. For granules, a drum coater or fluidized bed is used. For prills, a prilling tower is used. The finished granular urea product developed here is characterized in that each granule or prill is substantially homogeneous in nitrogen stabilizer distribution, carrier distribution, grain size and sphericity.

In one aspect, the invention provides a granular urea-nitrogen stabilizer composition comprising:

a) urea;

b) a nitrogen stabilizer comprising a urease inhibitor and no DCD, wherein the nitrogen stabilizer is at a concentration between about 0.02 wt. % and 1 wt. % of the composition;

and

c) a carrier system at a concentration between about 0.02 wt. % and 1.5 wt. % of the composition, wherein the carrier system comprises an organic solvent;

wherein said nitrogen stabilizer and said carrier system are substantially homogeneously dispersed throughout the radial thickness of the granule.

In another aspect, the invention provides a granular urea-nitrogen stabilizer composition comprising:

a) urea;

b) a nitrogen stabilizer comprising a urease inhibitor and no DCD, wherein the nitrogen stabilizer is at a concentration between about 0.02 wt. % and 1 wt. % of the composition; and

c) a carrier system at a concentration between about 0.02 wt. % and 1.5 wt. % of the composition, wherein the carrier system comprises an organic solvent;

wherein said nitrogen stabilizer and said carrier system are substantially homogeneously dispersed starting from a point between about 1% and 50% by radial length away from the granule center and continuing throughout the radial thickness of the granule.

In a further aspect, the invention provides a granular urea-nitrogen stabilizer composition comprising:

a) urea;

b) a nitrogen stabilizer comprising NBPT at a purity between 90 and 99%, wherein the nitrogen stabilizer is at a concentration between about 0.02 wt. % and 1 wt. % of the composition;

c) a carrier system at a concentration between about 0.02 wt. % and 1.5 wt. % of the composition; and

wherein said nitrogen stabilizer and said carrier system are substantially homogeneously dispersed throughout the radial thickness of the granule.

In yet another aspect, the invention provides a granular urea-nitrogen stabilizer composition comprising:

a) urea;

b) a nitrogen stabilizer comprising NBPT at a purity between 90 and 99%, wherein the nitrogen stabilizer is at a concentration between about 0.02 wt. % and 1 wt. % of the composition;

c) a carrier system at a concentration between about 0.02 wt. % and 1.5 wt. % of the composition; and

wherein said nitrogen stabilizer and said carrier system are substantially homogeneously dispersed starting from a point between about 1% and 50% by radial length away from the granule center and continuing throughout the radial thickness of the granule.

The carrier system can comprise any solvent system that is both: (1) stable at urea melt temperatures of ˜120° C.; (2) able to solvate the nitrogen stabilizer system; and (3) miscible in molten urea. Preferred carrier systems can be blends of NMP and an organic solvent (e.g. propylene glycol), or blends of NMP, propylene glycol, and alkyl ether, or blends of glycol ether and propylene glycol. The nitrogen stabilizer can be a urese inhibitor, such as NBPT. When NBPT is used, the NBPT concentration can be about 0.02 wt. % to 0.1 wt. % of the granule urea-nitrogen stabilizer composition. The nitrogen stabilizer can also include a nitrification inhibitor, such as DCD. The concentration of the nitrification inhibitor can be about 0.05 wt. % and 0.9 wt. % of the granular urea-nitrogen stabilizer composition.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure.

FIG. 1 discloses a urea-nitrogen stabilizer granule according to one aspect of the invention, wherein the nitrogen stabilizer and carrier system are substantially homogeneously dispersed throughout the radial thickness of the granule.

FIG. 2 discloses a urea-nitrogen stabilizer granule according to another aspect of the invention, wherein the nitrogen stabilizer and carrier system are substantially homogeneously dispersed starting from a point between 1% and 10% by radial length away from the granule center and continuing throughout the radial thickness of the granule.

### DETAILED DESCRIPTION OF THE INVENTION

The invention provides an improved urea granule with a nitrogen stabilizer and carrier system substantially homogenously dispersed throughout the granule thickness. Further, the invention provides an improved urea granule with a nitrogen stabilizer that remain stable over extended storage periods.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

The term “about” as used herein to modify a numerical value indicates a defined range around that value. If “X” were a specified value, “about X” would generally indicate a range of values from 0.95X to 1.05X. Any reference to “about X” specifically denotes at least the values X, 0.95X, 0.96X, 0.97X, 0.98X, 0.99X, 1.01X, 1.02X, 1.03X, 1.04X, and 1.05X. Thus, “about X” is intended to teach and provide written description support for a claim limitation of, e.g., “0.98X.” When the quantity “X” only includes whole-integer values (e.g., “X carbons”), “about X” indicates a range from (X-1) to (X+1). In this case, “about X” as used herein specifically indicates at least the values X, X-1, and X+1. When “about” is applied to the beginning of a numerical range, it applies to both ends of the range. Thus, “from about 0.2 to 2.0%” is equivalent to “from about 0.2% to about 2.0%.” When “about” is applied to the first value of a set of values, it applies to all values in that set. Thus, “about 2, 4, or 7%” is equivalent to “about 2%, about 4%, or about 7%.”

The term “substantially” as used herein indicates a variation of ±5%. For example, if substantially was used to modify a particle diameter distribution of 100 μm, then 90% of the particles would have a diameter of 100 μm, and 10% (i.e. ±5%) would have a particle size above or below 100 μm.

In some aspects of the present invention, the molten urea may initially contain up to about 70 wt. %, about 75 wt. %, about 80 wt. %, about 85 wt. %, about 80 wt. % urea in water, either from the source of the urea used or from the addition of UF85 and the like. Such a molten urea solution can be concentrated further by vacuum concentration, or evaporation at atmospheric pressure. Preferably, however, the concentration of water is reduced to between 0.15 wt. % and 0.75 wt. % of the composition, including 0.15 wt. % and 0.5 wt % of the composition. The lower water content is beneficial in reducing ammonia and carbon dioxide formation through the reaction with cyanic acid.

The nitrogen content of the urea-nitrogen stabilizer composition can vary between 20 wt. % and 46 wt. %, including 20 wt. % and 40 wt. %, 35 wt. % and 46 wt. %, and 40 wt. % and 46 wt. % based on the composition. The maximum nitrogen content of pure urea is 46 wt. %. In order to obtain nitrogen concentrations less than 46% in the composition, additional nitrogen containing sources, such as urea formaldehyde and ammonium nitrate can be added. Urea formaldehyde is advantageous since it acts as a slow-release for nitrogen, thereby slowing down the conversion of urea to ammonium.

### Urease Inhibitors

“Urease inhibitor” as used herein refers to a compound that reduces, inhibits, or otherwise slows down the conversion of urea to ammonium (NH₄⁺) in soil when the compound is present as opposed to the conversion of urea to ammonium (NH₄⁺) in soil when the compound is not present, but conditions are otherwise similar. Nonlimiting examples of urease inhibitors include thiophosphoric triamide compounds disclosed in U.S. Pat. No. 4,530,714. In other embodiments, the urease inhibitor is a phosphorous triamide having the formula:

X═P(NH₂)₂NR¹R²; (Formula I)

wherein X is oxygen or sulfur; and R¹ and R² are each a member independently selected from the group consisting of hydrogen, C₁-C₁₂ alkyl, C₃-C₁₂ cycloalkyl, C₆-C₁₄ aryl, C₂-C₁₂ alkenyl, C₂-C₁₂ alkynyl, C₅-C₁₄ heteroaryl, C₁-C₁₄ heteroalkyl, C₂-C₁₄ heteroalkenyl, C₂-C₁₄ heteroalkynyl, or C₃-C₁₂ cycloheteroalkyl. Illustrative urease inhibitors can include, but are not limited to, N-(n-butyl)thiophosphoric triamide (NBPT), N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene, thiopyridines, thiopyrimidines, thiopyridine-N-oxides, N,N-dihalo-2-imidazolidinone, N-halo-2-oxazolidinone, derivatives thereof, or any combination thereof. Other examples of urease inhibitors include phenylphosphorodiamidate (PPD/PPDA), hydroquinone, N-(2-nitrophenyl) phosphoric acid triamide (2-NPT), ammonium thiosulphate (ATS) and organo-phosphorous analogs of urea are effective inhibitors of urease activity (see e.g. Kiss and Simihaian, Improving Efficiency of Urea Fertilizers by Inhibition of Soil Urease Activity. Kluwer Academic Publishers, Dordrecht, The Netherlands, 2002; Watson, Urease inhibitors. IFA International Workshop on Enhanced-Efficiency Fertilizers, Frankfurt. International Fertilizer Industry Association, Paris, France 2005). In at least one embodiment, the urease inhibitor composition is or includes N-(n-butyl)thiophosphoric triamide (NBPT).

The preparation of phosphoramide urease inhibitors such as NBPT can be accomplished by known methods starting from thiophosphoryl chloride, primary or secondary amines and ammonia, as described, for example, in U.S. Pat. No. 5,770,771. In a first step, thiophosphoryl chloride is reacted with one equivalent of a primary or secondary amine in the presence of a base, and the product is subsequently reacted with an excess of ammonia to give the end product. Other methods include those described in U.S. Pat. No. 8,075,659, where thiophosphoryl chloride is reacted with a primary and/or secondary amine and subsequently with ammonia. However this method can result in mixtures. Accordingly, when N-(n-butyl)thiophosphoric triamide (NBPT) or other urease inhibitors are used, it should be understood that this refers not only to the urease inhibitor in its pure form, but also to industrial grades of the material that may contain up to about 50% wt. %, about 40% about 30%, about 20% about 19 wt. %, about 18 wt. %, about 17 wt. %, about 16 wt. %, about 15 wt. %, about 14 wt. %, about 13 wt. %, about 12 wt. %, about 11 wt. %, 10 wt. %, about 9 wt. %, about 8 wt. %, about 7 wt. %, about 6 wt. % about 5 wt. %, about 4 wt. %, about 3 wt. % about 2 wt. % about 1 wt. % impurities, depending on the method of synthesis and purification scheme(s), if any, employed in the production of the urease inhibitor. A typical impurity is PO(NH₂)₃ which can catalyze the decomposition of NBPT under aqueous conditions. Thus in some embodiments, the urease inhibitor used is about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9% pure. Ranges of NBPT purity include: 90% to 99%, 92% to 99%, and 95% to 99%.

In one group of aspects, the amount of the urease inhibitor in the urea-nitrogen stabilizer composition is between about 0.02 wt. % and 0.1 wt. %, including 0.02 wt. % and 0.08 wt. %, 0.02 wt. % and 0.07 wt. %, 0.02 wt. % and 0.065 wt. %, 0.03 wt. % and 0.07 wt. %, 0.03 wt. % and 0.065 wt. %, 0.04 wt. % and 0.065 wt. %, and 0.05 wt. % and 0.07 wt. % based on the total weight of the urea-nitrogen stabilizer composition.

### Nitrification Inhibitors

In some aspects, the molten urea-nitrogen stabilizer composition further comprises a nitrification inhibitor or ammonia stabilizer. “Nitrification inhibitor” as used herein refers to a compound that reduces, inhibits, or otherwise slows down the conversion of ammonium (NH₄⁺) to nitrate in soil when the compound is present as compared to the conversion of ammonium (NH₄⁺) to nitrate in soil when the compound is not present, but conditions are otherwise similar. Illustrative nitrification inhibitors can include, but are not limited to dicyandiamide (DCD), 2-chloro-6-trichloromethylpyridine (nitrapyrin), 3,4-dimethylpyrazole phosphate (DMPP), 3-methylpyrazole (MP); 1-H-1,2,4-triazole (TZ); 3-methylpyrazole-1-carboxamide (CMP); 4-amino-1,2,4-triazole (AT, ATC); 3-amino-1,2,4-triazole; 2-cyanimino-4-hydroxy-6-methylpyrimidine (CP); 2-ethylpyridine; ammonium thiosulfate (ATS); sodium thiosulfate (ST); thiophosphoryl triamide; thiourea (TU); guanylthiourea (GTU); ammonium polycarboxilate; ethylene urea; hydroquinone; phenylacetylene; phenylphosphoro diamidate; azadirachta indica Juss (Neem, neemcake); calcium carbide; 5-ethoxy-3-trichloromethyl-1,2,4-thiadiazol (etridiazol; terraole); 2-amino-4-chloro-6-methylpyrimidine (AM); 1-mercapto-1,2,4-triazole (MT); 2-mercaptobenzothiazole (MBT); 2-sulfanilamidothiazole (ST); 5-amino-1,2,4-thiadiazole; 2,4-diamino-6-trichloromethyl-s-triazine (CL-1580); N-2,5-dichlorophenyl succinanilic acid (DCS); nitroaniline, chloroaniline, 2-amino-4-chloro-6-methyl-pyrimidine, 1,3-benzothiazole-2-thiol, 4-amino-N-1,3-thiazol-2-ylbenzenesulfonamide, guanidine, polyetherionophores, 3-mercapto-1,2,4-triazole, potassium azide, carbon bisulfide, sodium trithiocarbonate, ammonium dithiocarbamate, 2,3-dihydro-2,2-dimethyl-7-benzofuranol methyl-carbamate, N-(2,6-dimethylphenyl)-N-(methoxyacetyl)-alanine methyl ester, ammonium thiosulfate, 1-hydroxypyrazole, 2-methylpyrazole-1-carboxamide, 2-amino-4-chloro-6-methyl-pyramidine, 2,4-diamino-6-trichloro-methyltriazine; and derivatives thereof, and any combination thereof.

For example, 1-hydroxypyrazole can be considered a derivative of 2-methylpyrazole-1-carboxamide and ammonium dithiocarbamate can be considered a derivative of methyl-carbamate. In at least one example, the nitrification inhibitor can be or include dicyandiamide (DCD). In at least one example, the nitrification inhibitor can be or include 3,4-dimethylpyrazole phosphate (DMPP). In at least one example, the nitrification inhibitor can be or include nitropyrin.

In one group of aspects, the nitrification inhibitor may contain about 50% wt. %, about 40% about 30%, about 20% about 19 wt. %, about 18 wt. %, about 17 wt. %, about 16 wt. %, about 15 wt. %, about 14 wt. %, about 13 wt. %, about 12 wt. %, about 11 wt. %, 10 wt. %, about 9 wt. %, about 8 wt. %, about 7 wt. %, about 6 wt. % about 5 wt. %, about 4 wt. %, about 3 wt. % about 2 wt. % about 1 wt. % impurities, depending on the method of synthesis and purification scheme(s), if any, employed in the production of the nitrification inhibitor.

In one group of aspects, the amount of the nitrification inhibitor in the urea-nitrogen stabilizer composition is about 0.05 wt. %, 0.06 wt. %, 0.07 wt. %, 0.08 wt. %, 0.09 wt. %, about 0.1 wt. %, about 0.2 wt. %, about 0.3 wt. %, about 0.4 wt. %, about 0.5 wt. %, about 0.6 wt. %, about 0.7 wt. %, 0.75 wt. %, about 0.8 wt. %, about 0.85 wt. %, and about 0.9 wt. % based on the total weight of the urea-nitrogen stabilizer composition. In some aspects, the urea-nitrogen stabilizer composition comprises a nitrification inhibitor in an amount between about 0.05% and about 0.9% by weight. In some aspects, the urea-nitrogen stabilizer composition comprises a nitrification inhibitor in an amount between about 0.2% and about 0.9% by weight. In some aspects, the urea-nitrogen stabilizer composition comprises a nitrification inhibitor in an amount between about 0.75 wt. % and about 0.9 wt. %.

In some aspects, the use of two specific additives, one to inhibit the urease-catalyzed hydrolysis of urea and the other to inhibit the nitrification of ammonia, in the fertilizer composition of this invention offers an opportunity to tailor the make-up of the composition to match the nitrogen nutrient demand of a given crop/soil/weather scenario. For example, if conditions are such that the opportunity for ammonia losses through volatilization to the atmosphere is thereby diminished, the level of the NBPT nitrogen stabilizer incorporated into the formulation may be reduced, within the specified range, without also changing the level of the nitrification inhibitor. The relative resistance of the granular fertilizer composition of this invention to urea hydrolysis and ammonia oxidation is controlled by properly selecting the urease inhibitor to nitrification weight ratio of the composition. This ratio can be from about 0.02 and to about 10.0, or about 0.04 and to about 4.0. For compositions with urease inhibitor to nitrification inhibitor weight ratios near the higher end of these ranges will exhibit relatively higher resistance to urea hydrolysis than to ammonium oxidation, and vice versa.

If both a urease inhibitor and a nitrification inhibitor are used, the urease inhibitor may be added previous to, simultaneously with or subsequent to the nitrification inhibitor. In some embodiments, the urease inhibitor and the nitrification inhibitor are mixed together before being added to the molten urea.

### Carriers

The present invention provides a nitrogen stabilizer composition with a liquid carrier system, that is incorporated into the molten urea. In some aspects, any suitable liquid organic solvent carrier capable of: (1) stability at urea melt temperatures ˜120° C.; and (2) at least partially solubilizing the nitrogen stabilizer can be used. In one group of embodiments, the liquid carrier has a boiling point higher than the melting (crystalline phase change) temperature of urea e.g. about 120° C. at atmospheric pressure. In one group of embodiments, the liquid carrier has a boiling point of at least 125° C. at atmospheric pressure. In another group of embodiments, the liquid carrier has a flash point higher than the melting temperature of urea. Non-limiting examples of liquid carriers include, but are not limited to an alcohol, a diester of a dicarboxylic acid, an alkyl carbonate, a cyclic carbonate ester; and mixtures thereof. Non-limiting examples of an alcohol include an alkanol, an alkenol, a hydroxyalkyl aryl compound, a glycol, glycerol, a glycol ether, a glycol ester, a poly(alkylene glycol), a poly(alkylene glycol) ether, an poly(alkylene glycol) ester, an ester of a hydroxyacid, and a hydroxylalkyl heterocycle.

In some aspects, the liquid carrier used with the nitrogen stabilizer composition comprises N-methyl 2-pyrrolidinone (NMP). NMP has a boiling point of ˜200° C. and can solubilizer NBPT. Further carriers can comprise glycols, or mixtures of NMP and glycols. In some aspects, the glycol is a C₂-C₆ aliphatic glycol. Examples include ethylene glycol; propylene glycol; 1,4-butanediol; 1,2-pentanediol; 1,3-hexanediol; and the like. In a particular aspect, the carrier comprises ethylene or propylene glycol. Additional glycols are set forth in, e.g., U.S. Pat. Nos. 5,698,003 and 8,075,659. Alkyl ethers can also be used in the liquid carrier as either a substitute for NMP or in addition to NMP (see description below). For example, the liquid carrier can include propylene glycol and alkyl ether, or propylene glycol, NMP, and alkyl ether.

In one group of aspects, the amount of liquid carrier used is the minimum amount to solubilize the amount of nitrogen stabilizer used. For example, if the nitrogen stabilizer is a urease inhibitor, the concentration of the liquid carrier in the nitrogen stabilizer is between about 80% and 40 wt. %, including between about 80% and 50 wt. %, and about 80% and 60 wt. %.

In one aspect, the liquid carrier comprises NMP and propylene glycol, the propylene glycol is in a concentration of about 15 wt. % to about 85 wt. %, and NMP in a concentration of about 15 wt. % to about 85 wt. % based on the total weight of the liquid carrier. Other ranges include propylene glycol in a concentration of about 10 wt. % to about 65 wt. %, and NMP in a concentration of about 35 wt. % to about 90 wt. %. In another aspect, the concentration of propylene glycol is between about 15 wt. % and 65 wt. % of the carrier system and the concentration of NMP is between about 35 wt. % and 85 wt. % of the carrier system. Thus, for example, in a 50:50 wt. % ratio mixture of NBPT and liquid carrier, the concentrations in the nitrogen stabilizer will be as follows: 50 wt. % NBPT, about 5-15 wt. % propylene glycol, and about 35-45 wt. % NMP. In an further example, in a 43:57 wt. % ratio mixture of NBPT and liquid carrier, the concentrations in the nitrogen stabilizer will be as follows: 43 wt. % NBPT, about 5-20 wt. % propylene glycol, and about 30-45 wt. % NMP.

In another aspect, the liquid carrier comprises alkyl ether (e.g. glycol ether) and propylene glycol. The alkyl ether is in a concentration of about 60 wt. % to about 80 wt. %, and the propylene glycol is in a concentration of about 20 wt. % to about 40 wt. % based on the total weight of the liquid carrier. For example, in a 35:65 wt. % ratio mixture of NBPT and liquid carrier, the concentrations in the nitrogen stabilizer will be as follows: 35 wt. % NBPT, about 39-52 wt. % alkyl ether, and about 10-26 wt. % propylene glycol.

The liquid carrier can also include various combinations of the below.

In some aspects, the liquid carrier comprises at least one member selected from the group consisting of an alcohol (including heterocyclic alcohols), an alkanolamine, a hydroxy acid, a diester of a dicarboxylic acid, an ester amide of a dicarboxylic acid, an alkyl carbonate, a cyclic carbonate ester and a glycol ether.

In some aspects, the liquid carrier is an alcohol. In some aspects, the alcohol is selected from the group consisting of an alkanol, an alkenol, a hydroxyalkyl aryl compound, a glycol, a glycol ether, a glycol ester, a poly(alkylene glycol), a poly(alkylene glycol) ether, an poly(alkylene glycol) ester, an ester of a hydroxyacid, and a hydroxylalkyl heterocycle. In some aspects, the carrier comprises a hydroxyalkyl aryl compound as set forth in, e.g., U.S. patent application Ser. No. 13/968,318.

In some aspects, the liquid carrier is an alkanolamine. Examples include but are not limited to ethanolamine, diethanolamine, triethanolamine, monoisopropanolamine, diisopropanolamine, 2-aminoethanol; 2- or 3-aminopropanol; 1-amino-2-propanol; 2- or 3-aminobutanol; 2-, 3-, or 4-aminopentanol; 2-, 3-, or 4-amino-2-methylbutanol; 3-aminopropylene glycol; and the like. Additional amino alcohols are set forth in, e.g., U.S. Pat. Publ. No. 2010/0206031, 2011/0113842, 2011/0259068, and U.S. Pat. No. 8,048,189.

In some aspects, the liquid carrier is a glycol ether. In some aspects, the ether's alkyl group is a C₁-C₆ aliphatic alkyl group, such as methyl, ethyl, butyl, isopropyl, or tert-butyl. In some aspect, the glycol ether comprises a C₁-C₆ aliphatic glycol as discussed herein, such as an glycol ether of ethylene glycol; propylene glycol; 1,4-butanediol; 1,2-pentanediol; 1,3-hexanediol; and the like. In a particular aspect, the glycol ether is an ether of ethylene or propylene glycol. Additional glycol ethers are set forth in, e.g., Intl. Pat. Publ. No. WO 2008/000196 and U.S. patent application Ser. No. 13/968,324.

In some aspects, the liquid carrier is 1,2-isopropylideneglycerol or glycerol acetonide):

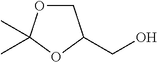

as disclosed in U.S. Patent Publication No. 2013/0145806.

In some aspects, the liquid carrier is a poly(alkylene glycol). The poly(alkylene glycol) can include glycol monomers of only one type, such as poly(ethylene glycol) or poly(propylene glycol), or may include more than one type, such as a copolymer of ethylene glycol and propylene glycol. The alkylene glycol monomer can be any of the types disclosed herein or in the publications incorporated by reference. In some aspects, the polymer is an oligomer comprising 2 to 16, 2 to 10, 2 to 6, 2 to 5, or 2 to 4 monomers, e.g., methyl or butyl ethers of di(ethylene glycol) or tri(ethylene glycol); a methyl ether of di(propylene glycol). In certain aspects, the poly(alkylene glycol) may be a solid, either at room temperature or under the conditions of addition. Additional poly(alkylene glycol)s are set forth in, e.g., Int'l. Pat. Publ. No. WO 2008/000196 and U.S. patent application Ser. No. 13/968,324.

In some aspects, the liquid carrier is a poly(alkylene glycol) ether. In some aspects, the ether's alkyl group is a C₁-C₆ aliphatic alkyl group, such as methyl, ethyl, butyl, isopropyl, or tert-butyl. In some aspects the glycol ether is dipropyleneglycol, monomethylether, diethyleneglycol monomethylether, triethyleneglycol monomethylether or diethyleneglycol monobutylether. In certain aspects, the poly(alkylene glycol) ether may be a solid, either at room temperature or under the conditions of addition. Additional glycol ethers are set forth in, e.g., Intl. Pat. Publ. No. WO 2008/000196 and U.S. patent application Ser. No. 13/968,324.

In some aspects, the liquid carrier comprises a poly(alkylene glycol) ester. In some aspects, the ester's alkyl group is a C₁-C₆ aliphatic alkyl group, such as methyl, ethyl, butyl, isopropyl, or tert-butyl. The poly(alkylene glycol) component of the ester can be any of the types disclosed or referenced herein. In certain aspects, the poly(alkylene glycol) ester may be a solid, either at room temperature or under the conditions of addition.

In some aspects, the liquid carrier comprises an ester of a hydroxy carboxylic acid. In some aspects, the ester's alkyl group is a C₁-C₆ aliphatic alkyl group, such as methyl, ethyl, butyl, isopropyl, or tert-butyl. In some other aspects, the hydroxy carboxylic acid is a C₂-C₆ aliphatic hydroxyacid, such as hydroxyacetic or lactic acid. Additional esters of hydroxy carboxylic acids are set forth in, e.g., U.S. Pat. Publ. No. 2010/0206031.

In some aspects, the liquid carrier is comprises a hydroxylalkyl heterocycle. Examples include a cyclic methylene or ethylene ether formed from ethylene glycol, propylene glycol, or any other 1,2-, 1,3-, or 1,4-diol-containing glycol as described or referenced in the aspects herein. Other examples include 5-, 6-, and 7-membered cyclic ethers with a hydroxymethyl or hydroxyethyl substituent, such as (tetrahydro-2H-pyran-4-yl)methanol. Additional hydroxylalkyl heterocycles are set forth in, e.g., U.S. Pat. Publ. No. 2010/0206031.

In some aspects, the liquid carrier is a diester of a dicarboxylic acid. In some aspects, the diester's alkyl groups, which can be the same or different, are C₁-C₆ aliphatic alkyl groups, such as methyl, ethyl, butyl, isopropyl, or tert-butyl. The carboxylic acid groups may be substituents of a C₁-C₆ aliphatic or alkylenic group, such as for malonic, 2-methylmalonic, succinic, maleic, or tartaric acid. Additional diesters of dicarboxylic acids are set forth in, e.g., U.S. Pat. Publ. No. 2001/0233474 and WO 2010/072184.

In some aspects, the liquid carrier is a mixed ester amide of a dicarboxylic acid. In some aspects, the ester's alkyl groups are those recited above. In some aspects, the amide group are unsubstituted or substituted amines. The substituents on the amino group, which can be the same or different, are C₁-C₆ aliphatic alkyl groups, such as methyl, ethyl, butyl, isopropyl, or tert-butyl. Examples of mixed ester amides of dicarboxylic acids include methyl 5-(dimethylamino)-2-methyl-5-oxopentanoate (Chemical Abstracts No. 1174627-68-9):

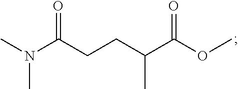

as set forth in, e.g., U.S. Patent Publication No. 2011/0166025.

In some aspects, the liquid carrier is an alkyl carbonate. In some aspects, the carbonate's alkyl groups are C₁-C₆ aliphatic alkyl groups, such as methyl, ethyl, butyl, isopropyl, or tert-butyl. The two alkyl groups can be the same or different (e.g., methyl ethyl carbonate). In some aspects, the alkyl carbonate is a lactate, such as (S)-ethyl lactate or propylene carbonate such as those disclosed in U.S. Patent Publication No. 2011/0233474).

In some aspects, the liquid carrier is a cyclic carbonate ester. Examples include a cyclic carbonate formed from ethylene glycol, propylene glycol, or any other 1,2-, 1,3-, or 1,4-diol-containing glycol as described or referenced in the aspects herein. Additional cyclic carbonate esters are set forth in, e.g., U.S. Pat. Publ. No. 2001/0233474. Other examples of suitable liquid formulations of (thio)phosphoric triamides can be found in WO 97/22568, which is referred to in its entirety.

In some aspects, the liquid carrier an aprotic solvent, such as a sulfoxide or sulfone, for example dimethylsulfoxide (DMSO) or 2,3,4,5-tetrahydrothiophene-1,1-dioxide (Sulfolane).

The carrier system is present between about 0.02 wt. % and 1.5 wt. % of the granular urea-nitrogen stabilizer composition. Other concentrations may include between about 0.02 wt. % and 1.0 wt. %, 0.02 wt. % and 0.5 wt. %, 0.02 wt. % and 0.2 wt. %, 0.02 wt. % and 0.1 wt. %, 0.02 wt. % and 0.08 wt. %, and 0.02 wt. % and 0.06 wt. %.

### Other Components

In a further group of aspects, the present invention provides a urea-nitrogen stabilizer composition that includes other components, including but not limited to: a conditioning agent, an anti-caking agent, a hardening agent, a pH control agent, a dye; and combinations thereof.

Examples of a conditioning agent include, but are not limited to mineral oil and the like. In some embodiments, the conditioning agent is added to the urea-nitrogen stabilizer composition after it is solidified into granules, prills, etc. In one embodiment, the conditioning agent is combined with the urea-nitrogen stabilizer composition in a ratio of about 3:1 urea-nitrogen stabilizer composition to conditioning agent.

In some aspects, an acidic compound can be included as a pH control agent to maintain or to adjust the pH of the molten urea-nitrogen stabilizer composition. Illustrative acids can include, but are not limited to, mineral acids such as hydrochloric acid, sulfuric acid, nitric acid, phosphoric acid, acetic acid or any combination thereof.

In some aspects, a basic compound can be included as a pH control agent to maintain or to adjust the pH of the molten urea-nitrogen stabilizer composition. Illustrative base compounds for adjusting the pH can include, but are not limited to, ammonia, amines, e.g., primary, secondary, and tertiary amines and polyamines, sodium hydroxide (NaOH), potassium hydroxide (KOH), or a combination thereof.

In some aspects, another pH control agent or buffering agent can be included to maintain or to adjust the pH of the molten urea-nitrogen stabilizer composition. Illustrative pH buffering compounds can include, but are not limited to, triethanolamine, sodium borate, potassium bicarbonate, sodium carbonate, potassium carbonate, or any combination thereof.

Examples of an anti-caking agent include, but are not limited to lime, gypsum, silicon dioxide, kaolinite, or PVA in amounts from approximately 1 to approximately 95% by weight, in addition to the active substance mixture.

The pigments or dyes can be any available color are typically considered non-hazardous. In some embodiments, the dye is present in less than about 1 wt %, about 2 wt. % or less than about 3 wt. % of the urea-nitrogen stabilizer composition.

The additional components may be added to molten urea without a carrier, or with a solid or liquid carrier like the nitrogen stabilizer composition. The additional components can be mixed with the nitrogen stabilizer composition and added to the molten urea simultaneously, or they can be separately added, previous to, simultaneously with or subsequent to adding a nitrogen stabilizer composition.

### Processes for Making the Compositions

Incorporation of the Nitrogen Stabilizer Compositions into the Urea Melt

The incorporation of the nitrogen stabilizer compositions and liquid carrier into the molten urea is disclosed in U.S. application Ser. No. 14/468,174 or WO 2015/027244 (herein incorporated by reference in their entirety).

In some aspects of the present invention, the urease inhibitor, such as NBPT, is incorporated into the molten urea-nitrogen stabilizer composition by blending a concentrated mixture of urease inhibitor with a liquid carrier of this invention (“a urease inhibitor composition”) directly with molten urea at a temperature of about 115° C. to about 120° C. before the granulation or prilling of the urea in a conventional urea production facility. In certain aspects, sufficient mixing is employed during this blending step to assure that the urease inhibitor composition is substantially homogeneously distributed throughout the molten urea before the melt cools and solidifies in the subsequent granulation or prilling step. Typical residence times of the carrier and nitrogen stabilizer in the molten urea are less than 20 seconds, and between 5 and 15 seconds.

The concentrated urease inhibitor composition may contain between about 20% and 50% urease inhibitor by weight, and in certain aspects between about 50% and about 40% urease inhibitor by weight. Because of the urease inhibitor is in a concentrated form, only very limited quantities of a carrier of this invention need be introduced into the urea along with the urease inhibitor. For example, if the urease inhibitor content of a concentrated urease inhibitor solution is 50 wt. % (i.e. 50% liquid carrier) and the urease inhibitor content of a resulting fertilizer composition is 0.07 wt. %, the carrier content of the resulting fertilizer composition is at most 0.07 wt. %.

In some aspects of the present invention, in addition to a urease inhibitor such as NBPT, another additive, such as a nitrification inhibitor is also added to and blended with the molten urea before its granulation. Several methods can be used for the introduction of nitrification inhibitor into the molten urea. If available as a powder or in granular form, the nitrification inhibitor can be fed into a stream of molten urea using a conventional solids feeding device. In some aspects, the nitrification inhibitor may be dissolved in a relatively small quantity of molten urea, as for example in a side stream of molten urea in a urea plant, to form a concentrated nitrification inhibitor solution in molten urea that is then metered into the main stream of the molten urea. In some aspects, the nitrification inhibitor may be incorporated into the carrier system described herein and introduced into the molten urea along with the urease inhibitor.

Sufficient mixing should be provided to facilitate substantial homogenous distribution of the urease inhibitor and/or nitrification inhibitor throughout the urea melt. The substantial homogeneous distribution of the urease inhibitor and/or nitrification inhibitor in the granular fertilizer compositions of this invention enhances the performance of these compositions in terms of their ability to promote plant growth via reducing nitrogen loss and making available more nitrogen per pound of fertilizer.

The order in which the urease inhibitor and nitrification inhibitor are added to the molten urea in some aspects of this invention's methods is flexible. Either urease inhibitor or nitrification inhibitor may be introduced first, or both of these components may be added simultaneously. Initial addition of nitrification inhibitor can provide adequate time for both the dissolution and uniform distribution of the nitrification inhibitor in the molten urea before the granulation step. A convenient point for the addition of nitrification inhibitor to molten urea in a urea production plant would be before or between the evaporation steps used to reduce the water content of the molten urea. A concentrated urease inhibitor carrier, however, is in certain aspects introduced into the molten urea just before the granulation or prilling step with only sufficient retention time in the melt (i.e. 5-15 seconds) to allow for substantially homogenous distribution of the urease inhibitor in the melt.

### Urea Production Process

Urea from a urea synthesis plant is produced in an aqueous liquid form with concentrations generally near 73-77 wt. % urea and the balance typically water (majority) and impurities (minority). This liquid is often transformed into a solid form for ease of handling and storage for many end uses. There are three major methods that are used to create a solid urea product: (1) rotating drum granulation; (2) prilling; and (3) fluid bed granulation. The first step in all of these methods is to concentrate the liquid urea from 73-77 wt. % up to 94-99 wt. % by the use of a steam evaporator to remove water. The concentrated urea liquor will freeze at temperatures between about 100 and 118° C., so it must be maintained at elevated temperatures (e.g. 120° C.) to stay in liquid form.

### Rotating Drum Granulation Process

Rotating drum granulation uses concentrated hot urea liquor (˜99% urea) from the evaporation step. The molten urea is pumped through a spraying system and onto a rolling bed of solid urea granules located inside a rotating drum. To start the granulation process the first time, the drum must be “seeded” with a bed of small urea particles onto which the molten urea can be sprayed. Once the system has produced granular product, this product is then saved and reused as start-up seed during the next run. With the granulation drum bed of urea particles in place, the rotation of the drum lifts and rolls the bed of granules slightly up the side of the drum in the direction of the rotation. A spraying system enters the drum near the centerline through a non-rotating end breeching. The spray nozzles are positioned to spray onto the rolling bed of solid urea granules in a manner that coats these granules with a thin layer of molten urea. Air is drawn through the granulation drum by outside fans for the purpose of removing the heat from the thin layer of molten urea causing it to solidify. As the bed rolls, the spraying and cooling of the urea layers onto the granules is repeated many times and the granules grow in size with each layer. The drum is positioned on a slight decline such that the mass of the solid granules formed are discharged after they have been grown to the desired size. The granules that discharge the granulation section are then cooled to near ambient temperature and screened to give proper sizing similar to the prilled product. Any non-conforming sizes from the screening process are usually recycled back into the inlet of the granulation system. The undersized material will then be grown to a larger desired size. The oversized material is sent through a crusher first where it is ground into small particles that are then added back to the inlet of the drum as seed material for the process.

### Prilling

The concentrated hot urea liquor from the evaporation step above is pumped to a prilling tower, which is a large, tall, hollow spray tower with multiple shower generating heads at the top that form streams of individual droplets of hot, liquid urea that fall down the tower. Air is introduced in the bottom of the tower, either by fans or natural convection, and the air flows up the tower counter current to the dropping streams of liquid urea. As the urea droplets fall through the air, they cool to below the freezing point by giving up heat to the air and thus form small, round, solid pellets called prills. The solid urea prills are then collected at the bottom of the tower and are conveyed to cooling systems that reduce the prill temperature to near ambient. The bulk dry, cool prills are then screened for proper sizing and sent to storage. Any non-conforming sizes are usually recycled back into the liquid system for repriling.

### Fluid Bed Granulation

Fluid bed granulation works in a very similar manner to the rotating drum granulation except that the method for “rotating” or “rolling” the small seed particles in a fluid bed granulator is by the use of large volumes of air blown up through a bed of particles. The floor of a fluid bed granulator is usually a thin metal plate with large numbers of small holes or perforations in it. These holes are too small for the seed particles to fall through, but are large enough for air to pass up into the bed of particles. As the large volume of air passes through the bed of seed particles, it lifts up and spins the particles a short distance until there is room for the air to pass up and away at which time the particles fall back down. This is called fluidization and it makes the bed of solid particles look like waves of fluid in a lake, hence the name fluid bed. Inside this fluid bed granulator, just above the perforated floor, are a series of spray nozzles that are situation to spray concentrated molten urea onto the fluidized bed of particles. As the air moves and rolls the particles through the sprays, thin layers of molten urea from the spray nozzles are added in a similar fashion as in the rotating drum system. The air also serves as the cooling medium to remove the heat from the molten urea layer causing it to solidify on the granule. As the now solid particles fall back down, the process can be repeated over and over again forming additional layers and thus larger particles. The discharge side wall of the fluid bed granulator has an opening in it at a set level or height so that the bed of material must be grown in volume by the addition of molten urea to a level that pushes the granules out of the discharge opening. The granules that discharge the granulation process section are then cooled to near ambient temperature and screened to give proper sizing, similar to other processes. Any non-conforming sizes from the screening process are again recycled back into the inlet of the granulation system. The undersized material will then be grown to a larger desired size. The oversized material is sent through a crusher first where it is ground into smaller particles that are then added back to the inlet of the fluid bed granulation system as seed material for the process.

Using the processes above, the granular urea-nitrogen stabilizer composition of the present invention has a granulometry of between about 60% and 95% with granules between 2-4 mm. Further granulometries include between about 70% and 95%, 80% and 95%, 80% and 90%, 85% and 95%, and 90% and 95%.

In addition to the above granulation processes used to make the instant compositions, the starting material in the rotating drum or fluid bed granulation process can also vary.

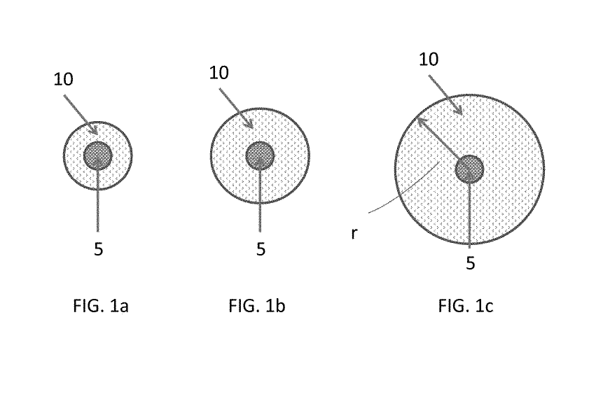

FIG. 1 discloses one aspect of the invention, where the starting material 5 (i.e. urea seed or crystal) is a urea granule containing nitrogen stabilizer and carrier substantially homogeneously dispersed throughout the urea seed. FIGS. 1a, 1b, and 1c show the progressive addition of stabilized urea 10 to the granule as it goes through the granulation process. FIG. 1c is the final granule, wherein “r” represents the radial thickness of the granular urea-nitrogen stabilized composition.

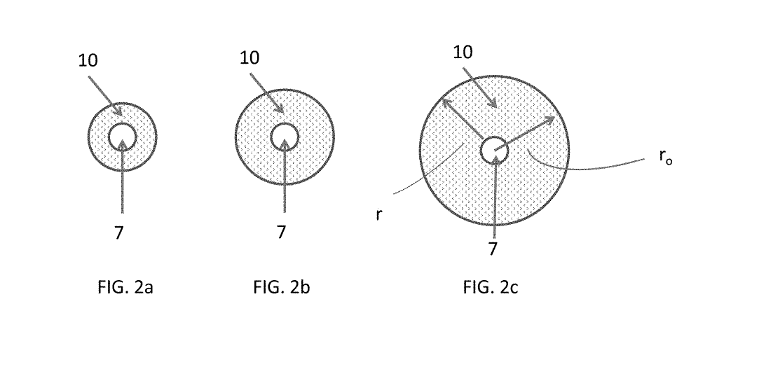

FIG. 2 discloses another aspect of the invention, where the starting material 7 is a urea granule without any nitrogen stabilizer or carrier (i.e. a pure urea seed or crystal). FIGS. 2a, 2b, and 2c show the progressive addition of stabilized urea 10 to the granule as it goes through the granulation process. FIG. 2c is the final granule. Here the nitrogen stabilizer and carrier are substantially homogenously dispersed at a radial thickness “r”, which starts at a point about 1% to 50% away, including about 1% to 25% away and about 1% to 10% away, from the total radial thickness “rₒ”. The percent away from the total radial thickness (granule center) “Δᵣₒ₋ᵣ” is calculated as follows: (rₒ−r)/rₒ*100. For example, if rₒ=4 mm and r=3.9 mm, then rₒ−r=0.1 mm and Δᵣₒ₋ᵣ=2.5%.

In a drum granulator, the urea seed from either aspect disclosed above is first introduced as a starting point for the addition of urea with the nitrogen stabilizer and carrier compositions. As the drum rotates, the instant composition of urea with nitrogen stabilizer and carrier is added, thereby applying coats of composition on top of the urea seed. The composition coating amount depends on the desired concentration of nitrogen stabilizer in the finished urea granule.

A similar process is also used with a fluidized bed granulation system. Here, the urea seeds are suspended in a bed of air as the instant composition is introduced via spray nozzles. The spray containing droplets of the instant composition adheres to the urea seed. Once the granule reaches a desired size and coating reaches a desired weight (and nitrogen stabilizer composition), the finished urea granule will be discharged from the bed.

### Uses

The homogenous granular urea-based fertilizer composition of this invention can be used in all agricultural applications in which granular urea is currently used. These applications include a very wide range of crop and turf species, tillage systems, and fertilizer placement methods. Most notably, the fertilizer composition of this invention can be applied to a field crop, such as corn or wheat, in a single surface application and will nevertheless supply sufficient nitrogen to the plants throughout their growth and maturing cycles. The fertilizer composition of this invention is capable of supplying the nitrogen nutrient with greater efficiency than any previously known fertilizer composition. The new improved composition increases the nitrogen uptake by plants, enhances crop yields, and minimizes the loss of both ammonium nitrogen and nitrate nitrogen from the soil.

The rate at which the fertilizer composition of this invention is applied to the soil may be identical to the rate at which urea is currently used for a given application, with the expectation of a higher crop yield in the case of the composition of this invention. Alternately, the composition of this invention may be applied to the soil at lower rates than is the case for urea and still provide comparable crop yields, but with a much lower potential for nitrogen loss to the environment.

The incorporation of a high purity urease inhibitor offers an opportunity to use less fertilizer per acre of coverage. Further, the removal of DCD results in a composition with surprisingly better ammonia volatization qualities than known compositions that use DCD.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1: Ammonia Volatization with and without DCD

Ammonia Volatization was measured as follows. One tbsp of water was used to moisten 4 oz (˜100 g) of Tifton, Ga. soil of pH 7.7. The moist soil was placed in an 8 oz plastic cup with a tight-fitting lid. Approximately 1 tsp (˜2 g) of the below samples was applied to the soil surface and the container was sealed. The container was incubated at room temperature for three days and analyzed for ammonia volatilization by inserting an ammonia-sensitive Dräger tube through the lid of the sealed container. In this way, the amount of ammonia present in the headspace of the container was quantified up to 600 ppm, the limit of the Dräger tube. In general, more effective urease inhibitors are characterized by having lower concentrations of ammonia in the headspace. All tests were run in duplicate in the presence of a positive control (i.e., untreated urea), which typically exhibits >600 ppm ammonia after 3 days following application.

TABLE 1

| | | Inventive granular urea- |
|---|---|---|
| | Stabilized Urea similar | nitrogen stabilizer com- |
| | to with DCD | position without DCD |
| Carrier system | 70 wt. % NMP and 30 | 67 wt. % NMP and 33 |
| | wt. % propylene glycol | wt. % propylene glycol |
| NBPT concentration | 0.085 wt. % | 0.06 wt. % |
| in the finished urea | | |
| DCD concentration | 0.85 wt. % | NA |
| in the finished urea | | |

TABLE 2

| Day | DCD Sample Ammonia | Inventive Sample Ammonia |
|---|---|---|
| tested | Volatization average (ppm) | Volatization average (ppm) |
| 3 | 0 | 0 |
| 4 | 3.5 | 0 |
| 5 | 12.5 | 2 |
| 6 | 119 | 1 |
| 7 | 250 | 3 |
| 8 | 600 | 50 |
| 9 | 600 | 300 |

A person of skill in the art would expect the fertilizer with DCD to have a lower or the same ammonia volatization as the inventive composition because of the higher NBPT concentration and DCD addition. Surprisingly, however, it was found that the inventive composition had a lower nitrogen loss with less NBPT and no DCD.

### Example 2: NBPT Stability Results at 85% Pure NBPT and 98% Pure NBPT

The compositions of one aspect of the were stored at various temperatures at daylight in glass, well-sealed containers. Remaining NBPT was measured using HPLC at various times.

TABLE 3
22° C. Storage Temperature Results

| | | | | | | % NBPT |
|---|---|---|---|---|---|---|
| | Time | | | | t = 6 | remaining |
| | (t) = 0 days | | | | months | after 6 |
| Sample | (d) | t = 32 d | t = 56 d | t = 91 d | (m) | months |
| NBPT | 960 | 820 | 830 | 845 | 620 | 64.58% |
| (85% pure) | | | | | | |
| and Urea | | | | | | |
| NBPT | 920 | 855 | 880 | 865 | 645 | 70.11% |
| (98% pure) | | | | | | |
| and Urea | | | | | | |
| NBPT | 780 | 740 | 750 | 655 | 595 | 76.28% |
| (85% | | | | | | |
| pure), | | | | | | |
| Urea, and | | | | | | |
| DCD | | | | | | |
| NBPT | 950 | 885 | 890 | 740 | 825 | 86.84% |
| (98% | | | | | | |
| pure), | | | | | | |
| Urea, and | | | | | | |
| DCD | | | | | | |

TABLE 4
45° C. Storage Temperature Results

| | | | | | | % NBPT |
|---|---|---|---|---|---|---|
| | Time | | | | t = 6 | remaining |
| | (t) = 0 days | | | | months | after 6 |
| Sample | (d) | t = 32 d | t = 56 d | t = 91 d | (m) | months |
| NBPT | 960 | 610 | 555 | 390 | 0 | 0% |
| (85% pure) | | | | | | |
| and Urea | | | | | | |
| NBPT | 920 | 660 | 595 | 425 | 20 | 2.17% |
| (98% pure) | | | | | | |
| and Urea | | | | | | |
| NBPT | 780 | 620 | 545 | 460 | 220 | 28.21% |
| (85% | | | | | | |
| pure), | | | | | | |
| Urea, and | | | | | | |
| DCD | | | | | | |
| NBPT | 850 | 790 | 725 | 620 | 375 | 44.12% |
| (98% | | | | | | |
| pure), | | | | | | |
| Urea, and | | | | | | |
| DCD | | | | | | |

As shown above, the presence of impurities in the urease inhibitor in the compositions promotes the decomposition of the urease inhibitor into non-effective substances during a longer storage and is the main cause of urease inhibitor degradation during a long term storage. As can be seen from the above tables, the purity of the urease inhibitor used has a stabilizing effect towards the final urease inhibitor composition. During storage over a 6 month period, the compositions using a less pure NBPT showed a significant decrease in the content of the urease inhibitor independent of temperature (at 22° C. or 45° C.) than compositions prepared using a purer form of NBPT. Surprisingly, the compositions that contained a nitrification inhibitor, such as DCD, showed a stabilizing effect on the decomposition of NBPT independent of NBPT purity, although compositions that used less pure NBPT showed a greater decrease in the content of the urease inhibitor than compositions prepared using purer form of NBPT, independent of the storage temperature.

Similarly, as will be apparent to one skilled in the art, various modifications can be made within the scope of the aforesaid description. Such modifications being within the ability of one skilled in the art form a part of the present invention and are embraced by the appended claims.

What is claimed is:

1. A granular urea-nitrogen stabilizer composition comprising:
a) urea;
b) a nitrogen stabilizer comprising a urease inhibitor and no DCD, wherein the nitrogen stabilizer is at a concentration between about 0.02 wt. % and 1 wt. % of the composition; and
c) a carrier system at a concentration between about 0.02 wt. % and 1.5 wt. % of the composition, wherein the carrier system comprises an organic solvent;
wherein said nitrogen stabilizer and said carrier system are substantially homogeneously dispersed throughout the radial thickness of the granule.

2. A granular urea-nitrogen stabilizer composition comprising:
a) urea;
b) a nitrogen stabilizer comprising a urease inhibitor and no DCD, wherein the nitrogen stabilizer is at a concentration between about 0.02 wt. % and 1 wt. % of the composition; and
c) a carrier system at a concentration between about 0.02 wt. % of the composition and 1.5 wt. % of the composition, wherein the carrier system comprises an organic solvent;
wherein said nitrogen stabilizer and said carrier system are substantially homogeneously dispersed starting from a point between 1% and 50% by radial length away from the granule center and continuing throughout the radial thickness of the granule.

3. A granular urea-nitrogen stabilizer composition comprising:
a) urea;
b) a nitrogen stabilizer comprising NBPT at a purity between 90 and 99%, wherein the nitrogen stabilizer is at a concentration between about 0.02 wt. % and 1 wt. % of the composition; and
c) a carrier system at a concentration between about 0.02 wt. % and 1.5 wt. % of the composition;
wherein said nitrogen stabilizer and said carrier system are substantially homogeneously dispersed throughout the radial thickness of the granule.

4. A granular urea-nitrogen stabilizer composition comprising:
a) urea;
b) a nitrogen stabilizer comprising NBPT at a purity between 90 and 99%, wherein the nitrogen stabilizer is at a concentration between about 0.02 wt. % and 1 wt. % of the composition; and
c) a carrier system at a concentration between about 0.02 wt. % and 1.5 wt. % of the composition;
wherein said nitrogen stabilizer and said carrier system are substantially homogeneously dispersed starting from a point between 1% and 50% by radial length away from the granule center and continuing throughout the radial thickness of the granule.

5. The granular urea-nitrogen stabilizer composition of either claim 3 or 4, wherein the nitrogen stabilizer composition further comprises a nitrification inhibitor at a concentration between about 0.05 wt. % and 0.9 wt. % of the composition.

6. The granular urea-nitrogen stabilizer composition of any of claims 1-4, wherein the urease inhibitor or NBPT is at a concentration between about 0.02 wt. % and 0.1 wt. % of the composition.

7. The granular urea nitrogen stabilizer of claim 5, wherein the nitrification inhibitor is at a concentration between about 0.05 wt. % and 0.75 wt. % of the composition.

8. The granular urea-nitrogen stabilizer composition of and of claims 1-4, wherein the urease inhibitor or NBPT is at a concentration between about 0.02 wt. % and 0.1 wt. % of the composition and the carrier system is at a concentration between about 0.02 wt. % and 0.2 wt. % of the composition.

9. The granular urea-nitrogen stabilizer composition of claim 1 or 2, wherein the urease inhibitor is NBPT.

10. The granular urea-nitrogen stabilizer composition of any of claim 1-4, wherein the carrier system is a mixture of NMP and propylene glycol.

11. The granular urea-nitrogen stabilizer composition of claim 10, wherein the concentration of NMP is between about 15 wt. % and 85 wt. % of the carrier system.

12. The granular urea-nitrogen stabilizer composition of claim 10, wherein the concentration of propylene glycol is between about 15 wt. % and 85 wt. % of the carrier system.

13. The granular urea-nitrogen stabilizer composition of claim 10, wherein the concentration of propylene glycol is between about 15 wt. % and 65 wt. % of the carrier system and the concentration of NMP is between about 35 wt. % and 85 wt. % of the carrier system.

14. The granular urea-nitrogen stabilizer composition of claim 13, wherein the concentration of propylene glycol is between about 0.005 wt. % and 0.65 wt. % of the composition and the concentration of NMP is between about 0.015 wt. % and 0.85 wt. % of the composition.

15. The granular urea-nitrogen stabilizer composition of claim 14, wherein the concentration of NBPT is between about 0.02 wt. % and 0.1 wt. % of the composition, the concentration of propylene glycol is between about 0.005 wt. % and 0.0275 wt. % of the composition, and the concentration of NMP is between about 0.015 wt. % and 0.09 wt. % of the composition.

16. The granular urea-nitrogen stabilizer composition of claim 5 or 7, wherein the nitrification inhibitor is DCD.

17. The granular urea-nitrogen stabilizer composition of any of claims 1-4, wherein the carrier system comprises a glycol ether.

18. The granular urea-nitrogen stabilizer composition of any of claims 1-4, wherein the carrier system comprises DMSO.

19. The granular urea-nitrogen stabilizer composition of claim 3 or 4, wherein the NBPT purity is between 95 and 99%.

20. The granular urea-nitrogen stabilizer composition of claim 3 or 4, wherein the NBPT has a purity of about 98%.

21. The granular urea-nitrogen stabilizer composition of claim 2 or 4, wherein said nitrogen stabilizer and said carrier system are substantially homogeneously dispersed starting from a point between 1% and 25% by radial length away from the granule center and continuing throughout the radial thickness of the granule.

22. The granular urea-nitrogen stabilizer composition of claim 2 or 4, wherein said nitrogen stabilizer and said carrier system are substantially homogeneously dispersed starting from a point between 1% and 10% by radial length away from the granule center and continuing throughout the radial thickness of the granule.
